(19) United States
(12) Patent Application Publication
(10) Pub. No.: US 2026/0093165 A1
(43) Pub. Date: Apr. 2, 2026

(54) ADJUSTMENT HANDLE

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 19/331,805

(22) Filed: Sep. 17, 2025

(30) Foreign Application Priority Data
Sep. 30, 2024 (CN) 2024224170018

(51) Int. Cl. G03B 17/56

(52) U.S. Cl. CPC G03B 17/563

(57) ABSTRACT

The present disclosure discloses an adjustment handle, which belongs to the field of photographic auxiliary equipment. The adjustment handle includes: a handle main body, an adjustment member, and a quick-release assembly. The quick-release assembly is movably disposed on either the handle main body or the adjustment member. By moving relative to the handle main body or the adjustment member, the quick-release assembly can selectively lock or unlock the handle main body and the adjustment member. Through the provision of the quick-release assembly between the adjustment member and the handle main body, the configuration enables detachable and rapid assembly and disassembly of the handle main body and the adjustment member, forming two separate modules. This configuration improves portability, facilitates shooting and replacement during use, and significantly enhances user convenience.

### CROSS-REFERENCE TO RELATED APPLICATIONS

The present application for patent claims priority to and the benefit of pending Chinese Application No. 2024224170018, filed September 30, 2024, which is hereby incorporated by reference herein as if fully set forth below in its entirety and for all applicable purposes.

### TECHNICAL FIELD

The present disclosure pertains to the field of photographic auxiliary equipment, especially to an adjustment handle.

### INTRODUCTION

In photography, users often need to adjust lens parameters such as zoom, focus, and aperture to achieve different compositions and effects. These adjustments are typically implemented by rotating the lens to capture the desired image. To facilitate such adjustments, parameter adjustment devices such as adjustment handles have been developed. These parameter adjustment devices typically include a handle main body and an adjustment member, enabling the user to hold the handle main body with one hand and operate the adjustment member with the other. However, in the prior art, the handle main body and the adjustment member of such adjustment handles are generally fixedly connected, which can be relatively inconvenient during use.

### BRIEF SUMMARY

To address the issues described above, the present disclosure provides an adjustment handle that offers greater flexibility in use.

Some aspects of the present disclosure provide an adjustment handle, including:

a handle main body, an adjustment member, and a quick-release assembly; the quick-release assembly is movably disposed on either the handle main body or the adjustment member; the quick-release assembly moves relative to the handle main body or the adjustment member to lock or unlock the handle main body and the adjustment member.

Compared with the prior art, by providing a quick-release assembly between the adjustment member and the handle main body, the handle main body and the adjustment member can be rapidly assembled and disassembled in a detachable manner. This allows the handle main body and the adjustment member to form two separate modules, thereby improving portability, facilitating shooting and replacement during use, and significantly enhancing user convenience.

### BRIEF DESCRIPTION OF THE DRAWINGS

FIG. 1 is a diagram illustrating an adjustment handle according to some aspects of the disclosure.

FIG. 2 is a diagram illustrating a handle main body according to some aspects of the disclosure.

FIG. 3 is an exploded view illustrating the handle main body of FIG. 2 according to some aspects of the disclosure.

FIG. 4 is a diagram illustrating a quick-release mechanism according to some aspects of the disclosure.

FIG. 5 is an exploded view illustrating the quick-release mechanism of FIG. 4 according to some aspects of the disclosure.

FIG. 6 is a diagram illustrating a focus adjustment module according to some aspects of the disclosure.

FIG. 7 is a diagram illustrating a part of a housing according to some aspects of the disclosure.

FIG. 8 is a diagram illustrating an adjustment member according to some aspects of the disclosure.

FIG. 9 is a cross-sectional view of the handle main body according to some aspects of the disclosure.

Reference Numerals: 1. handle main body; 11. housing; 12. positioning hole; 13. first terminal; 14. limiting chute; 141. first limiting chute; 142. second limiting chute; 15. movement through hole; 16. limiting support plate; 17. handle control circuit board; 18. expansion interface; 19. terminal through hole; 2. adjustment member; 21. positioning post; 22. second terminal; 3. quick-release assembly; 31. trigger member; 311. toggle part; 312. abutment part; 313. abutment inclined surface; 32. retaining member; 321. abutment arm; 322. retaining part; 3221. first retaining part; 3222. second retaining part; 323. limiting groove; 33. trigger return spring; 34. retaining return spring; 4. parameter adjustment module; 41. focus adjustment module; 411. parameter adjustment main board; 412. parameter adjustment dial; 413. encoder; 414. bearing; 415. magnetic member; 42. zoom adjustment module; 5. retaining groove.

### DETAILED DESCRIPTION

To further illustrate various aspects, the following description is provided with reference to the accompanying drawings and illustrative examples. It should be understood that the specific embodiments described herein are provided for the purpose of illustration and not intended to limit the scope of the present disclosure.

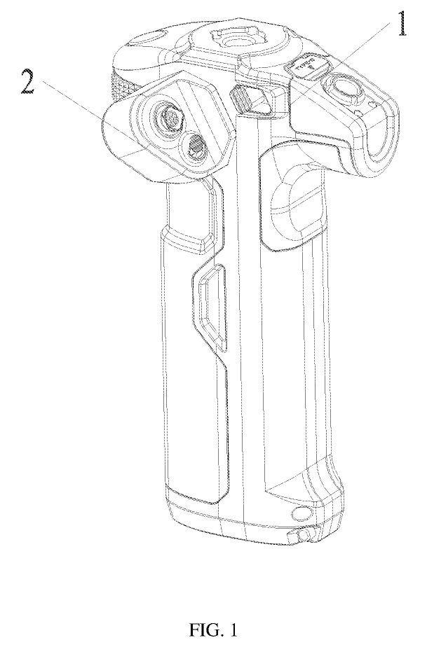

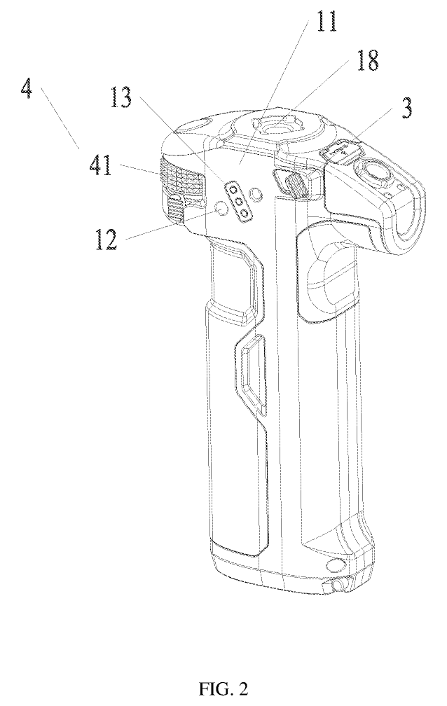

Referring to FIGS. 1-8, some aspects of the disclosure provide an adjustment handle that is convenient for users to hold and operate. It can communicate directly or indirectly with photographic equipment, such as via wireless or wired connections, to adjust lens parameters of the photographic equipment. As shown in FIGS. 1-2, the adjustment handle includes: a handle main body 1, a quick-release assembly 3, and an adjustment member 2. The quick-release assembly 3 is movably installed on either the handle main body 1 or the adjustment member 2, and is configured to lock the handle main body 1 to or unlock it from the adjustment member 2, enabling the disassembly and assembly of the adjustment member 2 and the handle main body 1. In this disclosure, the quick-release assembly 3 is movably disposed on the handle main body 1. This enables the adjustment member 2 to be detachably connected to the handle main body 1 via the quick-release assembly 3 and electrically connected to the handle main body 1 to enable communication between them.

Both the handle main body 1 and the adjustment member 2 are equipped with parameter adjustment modules 4. The circuit boards of the handle main body 1 and the adjustment member 2 can receive signals from the parameter adjustment modules 4 through devices such as magnetic encoders or pressure sensors to facilitate communication, thereby enabling adjustment of the lens parameters of the photographic equipment by operating the parameter adjustment modules 4. For example, it can control the aperture, focus, focal length, etc., of the photographic equipment lens.

In some aspects, the quick-release assembly 3 can move relative to the handle main body 1. When the quick-release assembly 3 is in a first position, the handle main body 1 and the adjustment member 2 are locked, allowing the user to secure the handle main body 1 and the adjustment member 2 together. When the quick-release assembly 3 is in a second position, the handle main body 1 and the adjustment member 2 are unlocked, enabling the user to remove the adjustment member 2 from the handle main body 1 or pre-assemble the adjustment member 2 to the handle main body 1. Accordingly, by controlling the movement of the quick-release assembly 3, rapid assembly and disassembly between the handle main body 1 and the adjustment member 2 can be achieved. This design allows the handle main body 1 and the adjustment member 2 to form two separate modules, improving portability, facilitating shooting and replacement during use, and significantly enhancing user convenience.

In some aspects, the handle main body 1 includes oppositely disposed first and second sides. The quick-release assembly 3 may be disposed on the first side. It is also conceivable that the quick-release assembly 3 may be disposed on the second side to enable switching between left-handed and right-handed use of the adjustment handle. For example, the quick-release assembly 3 of one handle may be movably disposed on the first side, while that of another handle may be disposed on the second side. This configuration allows the user to hold the adjustment handle with both hands and adjust different photographic equipment, etc.

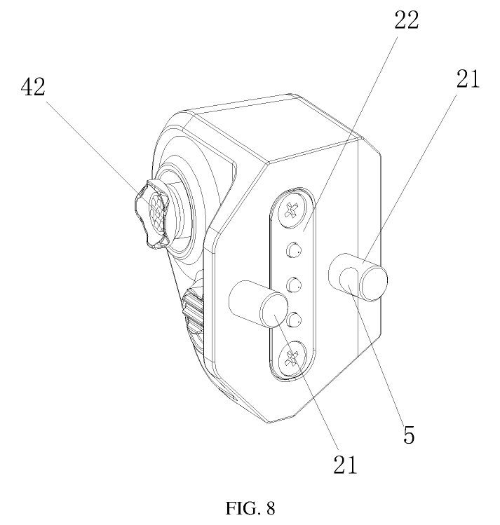

In some aspects, referring to FIG. 8, the adjustment member 2 includes a retaining groove 5. The quick-release assembly 3 can engage with or disengage from the retaining groove 5. The engagement between the quick-release assembly 3 and the adjustment member 2 is achieved through the retaining groove 5, facilitating disassembly and making operation more flexible and convenient.

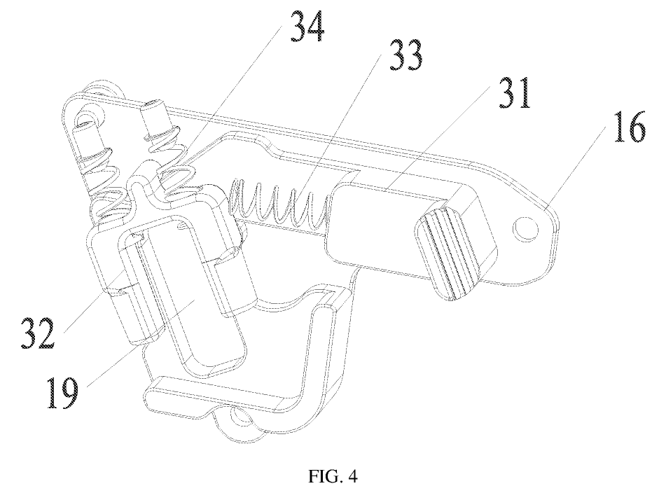

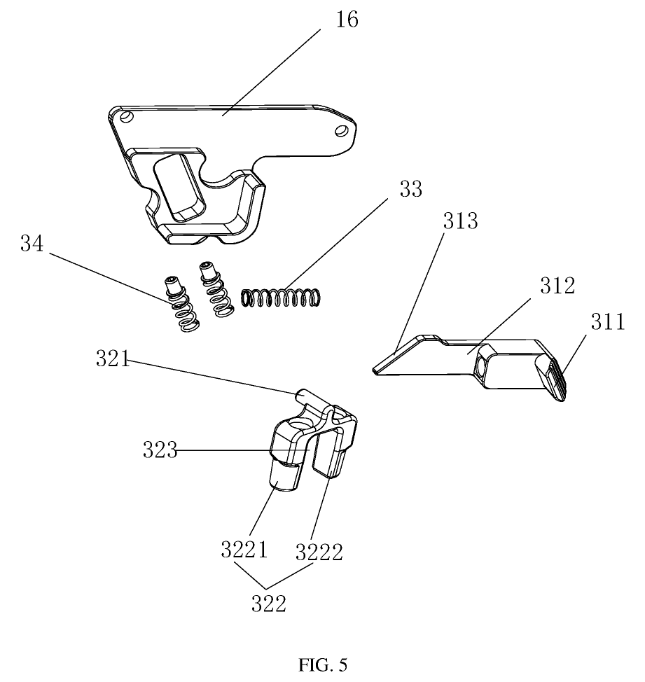

In some aspects, referring to FIGS. 4-5, the quick-release assembly 3 includes a trigger member 31 and a retaining member 32. Both the trigger member 31 and the retaining member 32 are movably disposed on the handle main body 1, and the trigger member 31 abuts against the retaining member 32. The retaining member 32 can engage with or disengage from the retaining groove 5. By controlling the movement of the trigger member 31, the trigger member 31 pushes the retaining member 32 to move to the second position. At this point, the retaining member 32 moves away from the retaining groove 5, allowing the user to pre-assemble the adjustment member 2 to the handle main body 1, or since the retaining member 32 is disengaged from the retaining groove 5, remove the adjustment member 2 from the handle main body 1. When the user releases the trigger member 31, the retaining member 32 moves to the first position and engages with the retaining groove 5, locking the connection between the handle main body 1 and the adjustment member 2. This configuration achieves rapid assembly and disassembly between the handle main body 1 and the adjustment member 2.

In some aspects, the handle main body 1 includes a housing 11. The housing 11 is provided with a positioning hole 12. The adjustment member 2 includes a positioning post 21. The positioning post 21 can extend through the positioning hole 12. The retaining groove 5 is disposed on the outer wall of the positioning post 21. When the trigger member 31 triggers the retaining member 32 to move from the first position to the second position, the retaining member 32 moves away from the retaining groove 5, allowing the user to pre-assemble the adjustment member 2 to the handle main body 1, or since the retaining member 32 is disengaged from the retaining groove 5, remove the adjustment member 2 from the handle main body 1. When the user releases the trigger member 31, the retaining member 32 moves to the first position, causing the retaining member 32 to be locked at the positioning post 21. This configuration achieves rapid assembly and disassembly between the handle main body 1 and the adjustment member 2. With the above configuration, when assembling the handle main body 1 and the adjustment member 2, the user operates the trigger member 31, inserts the positioning post 21 into the positioning hole 12, and then releases the trigger member 31. This configuration enables engagement between the retaining member 32 and the retaining groove 5. Operating the trigger member 31 again disengages the retaining member 32 from the retaining groove 5, achieving one-click locking or unlocking between the retaining member 32 and the retaining groove 5, and enabling rapid assembly and disassembly between the handle main body 1 and the adjustment member 2.

In some aspects, the trigger member 31 includes a toggle part 311 and an abutment part 312. The toggle part 311 can be elastically connected to the handle main body 1. The toggle part 311 can be fixedly connected to the abutment part 312. The toggle part 311 extends through the movement through hole 15 and is exposed on the handle main body 1. The retaining member 32 includes an abutment arm 321 and a retaining part 322. The retaining part 322 can be elastically connected to the handle main body 1. The abutment arm 321 can be connected to the retaining part 322. The end of the abutment part 312 is provided with an abutment inclined surface 313. The abutment inclined surface 313 is configured to fit closely with the abutment arm 321. The retaining part 322 engages with or disengages from the retaining groove 5. The end of the abutment part 312 is provided with the abutment inclined surface 313, which fits closely with the abutment arm 321, and the abutment arm 321 is capable of sliding relative to the abutment inclined surface 313. With the above structure, when the toggle part 311 is operated along the movement through hole 15, the toggle part 311 moves along the movement through hole 15, driving the abutment inclined surface 313 of the abutment part 312 to move. The abutment arm 321, fitting closely with the abutment inclined surface 313, slides relative to it, thereby triggering the entire retaining member 32 to move from the first position to the second position. At this time, the positioning post 21 can be inserted into the positioning hole 12, and the retaining part 322 is separated from the retaining groove 5. When the user releases the toggle part 311, the toggle part 311 returns to the first position along the movement through hole 15, thereby resetting the abutment arm 321 and the retaining part 322. At this time, the retaining part 322 engages with the retaining groove 5. In some aspects, the abutment arm 321 may be columnar or may have an inclined surface shape.

In some aspects, the retaining part 322 is a columnar structure, with one of its outer surfaces being a cylindrical surface. The retaining groove 5 is a concave arc-shaped groove with open ends. The arc-shaped groove is configured to match the cylindrical surface. When the user installs the adjustment member 2, the trigger member 31 first triggers the retaining member 32 to move to the second position. The positioning post 21 of the adjustment member 2 is inserted into the positioning hole 12 of the handle main body 1, pre-assembling the adjustment member 2 to the handle main body 1. Then, the user releases the trigger member 31, allowing the retaining member 32 to move to the first position. The cylindrical surface slides into the arc-shaped groove from the opening, achieving engagement between the retaining part 322 and the retaining groove 5 for locking. When the user triggers the retaining member 32 to move from the first position to the second position via the trigger member 31, the cylindrical surface slides out of the retaining groove 5 from the opening, disengaging the retaining part 322 from the retaining groove 5 for unlocking.

In some aspects, the retaining part 322 includes a first retaining part 3221 and a second retaining part 3222. Two positioning holes 12 and two positioning posts 21 are provided. The first retaining part 3221 and the second retaining part 3222 are respectively adjacent to the two positioning holes 12 and engage with or disengage from the retaining grooves 5 on the two positioning posts 21. In this embodiment, two retaining parts 322 are provided and oppositely disposed to improve structural stability.

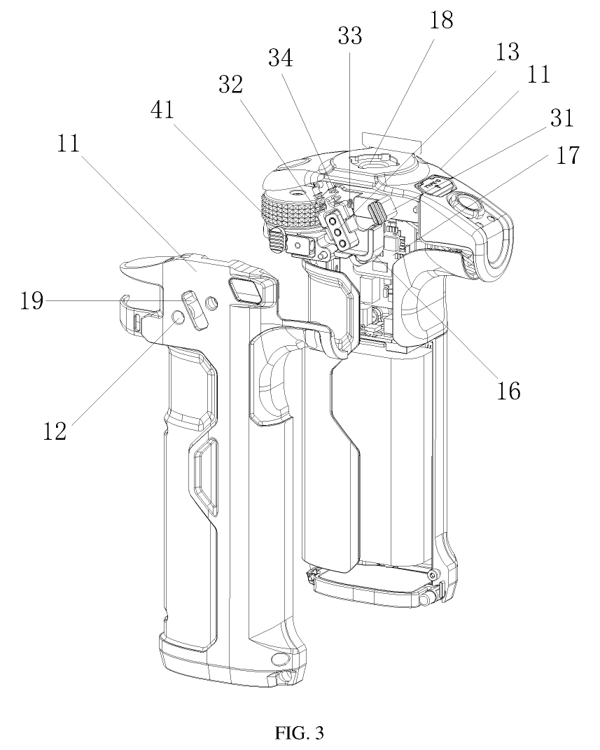

In some aspects, referring to FIGS. 2-3, the handle main body 1 further includes a first terminal 13, and the adjustment member 2 includes a second terminal 22. A limiting groove 323 is provided between the first retaining part 3221 and the second retaining part 3222. The upper portion of the first terminal 13 is located within the limiting groove 323. The second terminal 22 is disposed between the two positioning posts 21, and the first terminal 13 extends through the terminal through hole 19 on the housing 11 to electrically connect with the second terminal 22. The first terminal 13 is limited in position by the first retaining part 3221 and the second retaining part 3222, thereby improving structural stability. The first terminal 13 and the second terminal 22 may be electrically connected via pin contacts or plug-in electrical connections.

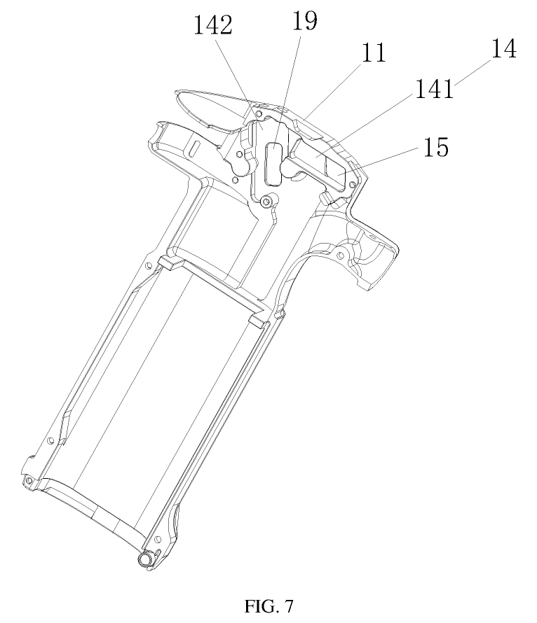

In some aspects, referring to FIG. 7, a limiting chute 14 is provided inside the housing 11. Two limiting chutes 14 are provided, namely a first limiting chute 141 and a second limiting chute 142. The abutment part 312 is movably disposed within the first limiting chute 141. The housing 11 further includes a movement through hole 15 communicating with the first limiting chute 141. One end of the toggle part 311 is disposed within the first limiting chute 141, while the other end extends through the movement through hole 15 and is exposed outside the housing 11, allowing movement within the movement through hole 15. The retaining member 32 is movably disposed within the second limiting chute 142. The first limiting chute 141 and the second limiting chute 142 limit the sliding travel of the trigger member 31 and the retaining member 32, ensuring that the trigger member 31 and the retaining member 32 move within a predetermined range. By constraining their movement via the first limiting chute 141 and the second limiting chute 142, structural stability is enhanced. The toggle part 311 protrudes outside the housing 11 through the movement through hole 15, allowing the user to operate the toggle part 311 from outside the housing 11. One end of the toggle part 311 slides within the movement through hole 15, thereby driving the entire trigger member 31 to move relative to the first limiting chute 141. This, in turn, triggers the movement of the retaining member 32 relative to the second limiting chute 142, enabling the transition of the retaining member 32 between the first position and the second position.

In some aspects, referring to FIGS. 2-3, the handle main body 1 can include a limiting support plate 16 fixedly installed on the housing 11. One side of the limiting support plate 16 is used to mount the handle control circuit board 17 of the handle main body 1. The limiting support plate 16 is also provided with a terminal through hole 19 to provide a clearance for the first terminal 13. The first terminal 13 extends through the terminal through hole 19 and can be electrically connected to the handle control circuit board 17. The other side of the limiting support plate 16, in combination with the limiting chute 14, forms a relatively enclosed movement space. The trigger member 31 and the retaining member 32 are both movably disposed within this movement space and are constrained by it. This configuration not only allows the quick-release assembly 3 to form an independent module without structural interference with the handle main body 1 but also enhances structural stability.

In some aspects, the quick-release assembly 3 can include a trigger return spring 33 and a retaining return spring 34. One end of the trigger return spring 33 abuts against or can be connected to the toggle part 311 or the abutment part 312, while the other end abuts against or can be connected to the inner wall of the housing 11. One end of the retaining return spring 34 abuts against or can be connected to the retaining part 322, while the other end abuts against or can be connected to the inner wall of the housing 11. After the trigger member 31 and the retaining member 32 are moved a certain distance under external force, upon removal of the external force, the trigger member 31 and the retaining member 32 can return to their original positions under the action of the trigger return spring 33 and the retaining return spring 34, respectively.

In some aspects, referring to FIGS. 2-3, the handle main body 1 can include an expansion interface 18 disposed at the end of the housing 11. In this embodiment, the expansion interface 18 is threaded, allowing the handle to be connected to expansion modules such as handheld or shoulder-mounted devices. This configuration enables the handle to not only support handheld or shoulder-mounted devices but also adjust camera lens parameters.

In some aspects, referring to FIGS. 2 and 8, the parameter adjustment module 4 includes a focus adjustment module 41 and a zoom adjustment module 42. The focus adjustment module 41 is disposed on the handle main body 1 and can be electrically connected to the handle control circuit board 17 for communication, enabling focus adjustment of the photographic equipment. The zoom adjustment module 42 is disposed on the adjustment member 2 and can be electrically connected to the handle control circuit board 17 via the second terminal 22 for communication, enabling zoom adjustment of the photographic equipment.

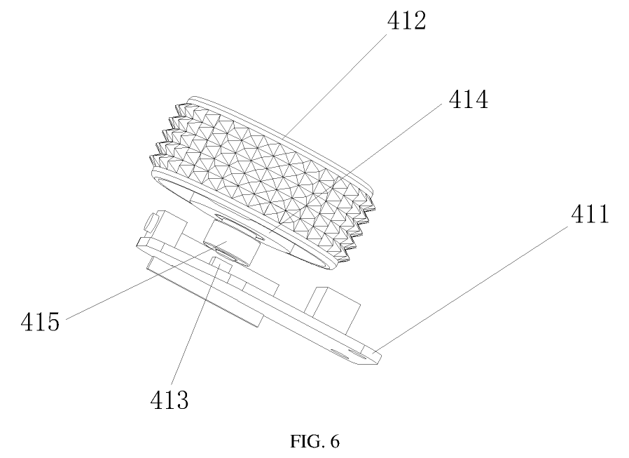

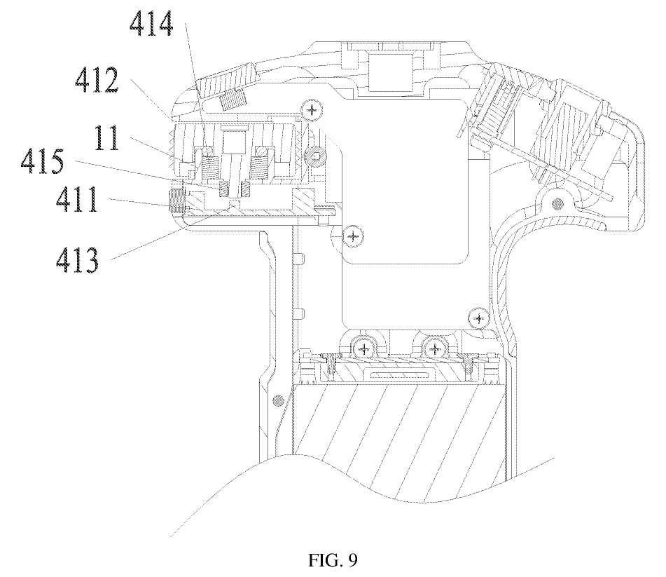

In some aspects, referring to FIGS. 6 and 9, the focus adjustment module 41 includes a parameter adjustment main board 411, a parameter adjustment dial 412, an encoder 413, a bearing 414, and a magnetic member 415. The parameter adjustment main board 411 can be electrically connected to the handle control circuit board 17. The encoder 413 can be electrically connected to the parameter adjustment main board 411. The encoder 413 and the bearing 414 are both disposed within the housing 11, and the parameter adjustment dial 412 is disposed on the housing 11 and exposed outside the housing 11. The bearing 414 is sleeved and disposed between the parameter adjustment dial 412 and the housing 11 to facilitate rotation of the parameter adjustment dial 412 relative to the housing 11. In some aspects, the housing 11 may have a protrusion similar to a shaft, and the bearing 414 is disposed between the protrusion and the parameter adjustment dial 412. The magnetic member 415 and the encoder 413 are both disposed at the bottom of the bearing 414, and the magnetic member 415 cooperates with the encoder 413. In this embodiment, the magnetic member 415 is a magnet. By operating the parameter adjustment dial 412 outside the housing 11, the magnet is driven to rotate relative to the encoder 413. The encoder 413 can detect the rotation angle of the magnet, thereby obtaining the adjustment angle of the parameter adjustment dial 412. The adjustment angle is then fed back to the handle control circuit board 17 via the parameter adjustment main board 411. The handle control circuit board 17 issues corresponding control commands to adjust the parameter (e.g., focus) of the photographic equipment.

As used in the claims, the indefinite articles "a" and "an" should be understood to mean "one or more" unless explicitly stated otherwise or unless the context clearly dictates a singular interpretation. The use of these articles does not limit the claimed invention to a single instance of the referenced element but rather encompasses multiple instances where applicable.

What is claimed is:

1. An adjustment handle comprising:
a handle main body, an adjustment member, and a quick-release assembly;
wherein the quick-release assembly is movably provided on the handle main body or the adjustment member; and
wherein the quick-release assembly is movable with respect to the handle main body or the adjustment member, and configured to selectively lock the handle main body with the adjustment member in a secured position and unlock the handle main body from the adjustment member from the secured position.

2. The adjustment handle according to claim 1, wherein the quick-release assembly is movably provided on the handle main body;
wherein the adjustment member is configured with a retaining groove; and
wherein the quick-release assembly is movable with respect to the handle main body to engage with or disengage from the retaining groove.

3. The adjustment handle according to claim 2, wherein the quick-release assembly comprises a trigger member and a retaining member;
wherein the trigger member and the retaining member are both movably arranged on the handle main body; and
wherein the trigger member is configured to connect to the retaining member, thus enabling the retaining member to engage with or disengage from the retaining groove.

4. The adjustment handle according to claim 3, wherein the trigger member comprises a toggle part and an abutment part;
wherein the abutment part is elastically connected to the handle main body;
wherein the toggle part is fixedly connected to the abutment part;
wherein the toggle part is exposed on the handle main body;
wherein the retaining member comprises an abutment arm and a retaining part;
wherein the retaining part is elastically connected to the handle main body;
wherein the abutment arm is connected to the retaining part; and
wherein the abutment part is configured to abut against the abutment arm to enable movement of the abutment arm, thus driving movement of the retaining part and enabling the retaining part to engage with or disengage from the retaining groove.

5. The adjustment handle according to claim 4, wherein an end of the abutment part is provided with an abutment inclined surface;
wherein the abutment arm is configured to abut against the abutment inclined surface;
wherein the abutment inclined surface is slidably connected to the abutment arm; and
wherein actuating the toggle part drives movement of the abutment inclined surface to push against the abutment arm, triggering movement of the retaining part.

6. The adjustment handle according to claim 3, wherein the handle main body comprises a housing;
wherein a side wall of the housing is provided with a limiting chute;
wherein the trigger member is movably provided within the limiting chute;
wherein a trigger return elastic member is provided between the trigger member and a wall of the limiting chute;
wherein the housing is further configured with a through hole communicating with the limiting chute; and
wherein an end of the trigger member away from the retaining member passes through the through hole to expose outside the housing.

7. The adjustment handle according to claim 6, wherein the housing is provided with a positioning hole;
wherein the adjustment member comprises a positioning post;
wherein the positioning post is configured to pass through the positioning hole;
wherein the retaining groove is provided on an outer wall of the positioning post; and
wherein in response to a movement of the retaining member, the retaining member is configured to engage or disengage from the positioning post.

8. The adjustment handle according to claim 7, wherein the retaining member comprises a first retaining part and a second retaining part;
wherein two positioning holes and two positioning posts are provided;
wherein each of the two positioning posts corresponds to each of the two positioning holes; and
wherein the first retaining part corresponds to a first one of the two positioning holes, the second retaining part corresponds to a second one of the two positioning holes, and the first retaining part and the second retaining part are configured to engage with or disengage from the retaining groove on the two positioning posts respectively.

9. The adjustment handle according to claim 1, wherein the handle main body comprises a first side and a second side that are opposite to one another; and
wherein the quick-release assembly is movably arrangeable on the first side or the second side so as to enable switching between left-handed and right-handed use of the adjustment handle.

10. The adjustment handle according to claim 1, wherein the handle main body comprises a first side and a second side that are opposite to one another; and
wherein the quick-release assembly is movably arrangeable on both the first side and the second side to switch left-handed and right-handed use of the adjustment handle.

11. The adjustment handle according to claim 8, wherein the handle main body further comprises a first terminal;
wherein the adjustment member comprises a second terminal;
wherein the retaining member is movably arranged in the limiting chute;
wherein a limiting groove is formed between the first retaining part and the second retaining part;
wherein the first terminal is located within the limiting groove;
wherein the second terminal is arranged between the two positioning posts; and
wherein the first terminal passes through the housing and is electrically connected to the second terminal.

12. The adjustment handle according to claim 6, further comprising a parameter adjustment module arranged on the adjustment member and the handle main body;
wherein the parameter adjustment module comprises a parameter adjustment main board, a parameter adjustment dial, an encoder, a bearing, and a magnetic member;
wherein the encoder is electrically connected to the parameter adjustment main board;
wherein the encoder and the bearing are both arranged within the housing;
wherein the parameter adjustment dial is arranged on the housing and exposed outside the housing;
wherein the bearing is arranged between the parameter adjustment dial and the housing;
wherein the magnetic member is arranged at a bottom of the bearing; and
wherein the magnetic member cooperates with the encoder.

13. The adjustment handle according to claim 6, further comprising a parameter adjustment module arranged on the adjustment member or the handle main body;
wherein the parameter adjustment module comprises a parameter adjustment main board, a parameter adjustment dial, an encoder, a bearing, and a magnetic member;
wherein the encoder is electrically connected to the parameter adjustment main board;
wherein the encoder and the bearing are both arranged within the housing;
wherein the parameter adjustment dial is arranged on the housing and exposed outside the housing;
wherein the bearing is arranged between the parameter adjustment dial and the housing;
wherein the magnetic member is arranged at a bottom of the bearing; and
wherein the magnetic member cooperates with the encoder.
